(19) United States
(12) Patent Application Publication
(10) Pub. No.: US 2016/0004784 A1
(43) Pub. Date: Jan. 7, 2016

(54) METHOD OF PROVIDING RELEVANT INFORMATION AND ELECTRONIC DEVICE ADAPTED TO THE SAME

(71) Applicant: Samsung Electronics Co., Ltd., Gyeonggi-do (KR)

(72) Inventors: Donghyun Roh, Gyeonggi-do (KR); Kyungsub Min, Gyeonggi-do (KR); Jaewon Lee, Gyeonggi-do (KR); Jinmook Lim, Gyeonggi-do (KR)

(21) Appl. No.: 14/790,622

(22) Filed: Jul. 2, 2015

(30) Foreign Application Priority Data
Jul. 4, 2014 (KR) 10-2014-0083587

(51) Int. Cl. G06F 17/30; G06F 3/0484; G06F 17/27

(52) U.S. Cl. CPC G06F 17/30905; G06F 17/30896; G06F 17/30867; G06F 17/30528; G06F 17/2785; G06F 3/04842

(57) ABSTRACT

Various embodiments of the present disclosure provide a method of providing relevant information and an electronic device adapted to the method. The method includes: displaying first information; extracting one or more retrieval words in a form of keyword or a form of phrase from the first information; obtaining second information as relevant information related to the first information by using the one or more extracted retrieval words; emphasizing objects corresponding to the one or more retrieval words on the first information; and displaying, when detecting the selection of at least one from the emphasized objects, the second information including the selected objects.

### CROSS-REFERENCE TO RELATED APPLICATION AND CLAIM OF PRIORITY

The present application is related to and claims benefit under 35 U.S.C. §119(a) of a Korean patent application filed on Jul. 4, 2014 in the Korean Intellectual Property Office and assigned Serial No. 10-2014-0083587, the entire disclosure of which is hereby incorporated by reference.

### TECHNICAL FIELD

Various embodiments of the present disclosure relate to a method of providing relevant information and an electronic device adapted to the method.

### BACKGROUND

In recent years, electronic devices have been developed to provide a variety of services. Examples of the services are information search, a voice chatting service, etc. Information search is performed by using a variety of databases, servers, etc. Searched content may be processed according to a user's request or may be output as it is searched. In particular, the information search function is performed based on web pages, and includes functions for providing information and suggesting similar web pages.

A voice chatting service is provided based on a technology for convening speech into text and providing the relevant information. The technology includes: converting a user's speech to text, analyzing the converted text, searching for information related to the ongoing conversation based on the analyzed text and providing the searched information.

### SUMMARY

However, in order to suggest similar web pages, conventional electronic devices need to crawl and analyze web pages before suggesting the similar web pages and to manage information about the analyzed web pages through a server. This burdens the server to manage a great amount of data, and also causes the server not to consider the latest web pages according to the period of crawling or analysis.

The technology of a voice chatting service for providing information related to a conversation causes a user, making a voice chatting, to lower the concentration of her attention on the use of the voice chatting service as it shows a list of retrieval words in process of searching for the results.

To address the above-discussed deficiencies, it is a primary object to provide a method of providing information related to data that is provided by text-based applications and an electronic device adapted to the method.

In accordance with various embodiments of the present disclosure, the present disclosure provides a method of providing relevant information by an electronic device comprising: displaying first information; extracting one or more retrieval words in a form of keyword or a form of phrase from the first information; obtaining the second information as relevant information related to the first information by using the one or more extracted retrieval words; emphasizing objects corresponding to the one or more retrieval words on the first information; and displaying, when detecting the selection of at least one from the emphasized objects, the second information including the selected objects.

In accordance with another embodiment of the present disclosure, the present disclosure provides an electronic device comprising: a display for displaying first information as a text-based application is executed and second information related to the first information; a memory that includes: a mapping table where keywords and phrases, used to obtain second information as relevant information related to the first information, are mapped to the second information and the mapped results are stored; and a database (DB) for obtaining the second information; and an information providing module for controlling a communication module to search for the second information from an external DB. The information providing module: displays the first information; extracts one or more retrieval words in a form of keyword and/or a form of phrase from the first information; obtains the second information as relevant information related to the first information by using the one or more extracted retrieval words; emphasizes objects corresponding to the one or more retrieval words on the first information; and sets to display, when detecting the selection of at least one from the emphasized objects, the second information including the selected objects.

Before undertaking the DETAILED DESCRIPTION below, it may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network environment including an electronic device according to various embodiments of the present disclosure:

FIG. 2 illustrates a schematic block diagram of an information providing module of an electronic device according to various embodiments of the present disclosure;

FIG. 3 illustrates a method of providing relevant information by an electronic device according to various embodiments of the present disclosure;

FIG. 4 illustrates a process of highlighting at least one of the following: keywords and phrases containing relevant information in an electronic device according to various embodiments of the present disclosure;

FIGS. 5A, 5B, and 5C illustrate diagrams that provide relevant information according to various embodiments of the present disclosure;

FIGS. 6A and 6B are diagrams that provide relevant information according to various embodiments of the present disclosure;

FIG. 7 illustrates a method of providing relevant information by an electronic device according to various embodiments of the present disclosure;

FIG. 8 illustrates a block diagram of an electronic device according to various embodiments; and

FIG. 9 illustrates communication protocols between a plurality of electronic devices according to various embodiments.

### DETAILED DESCRIPTION

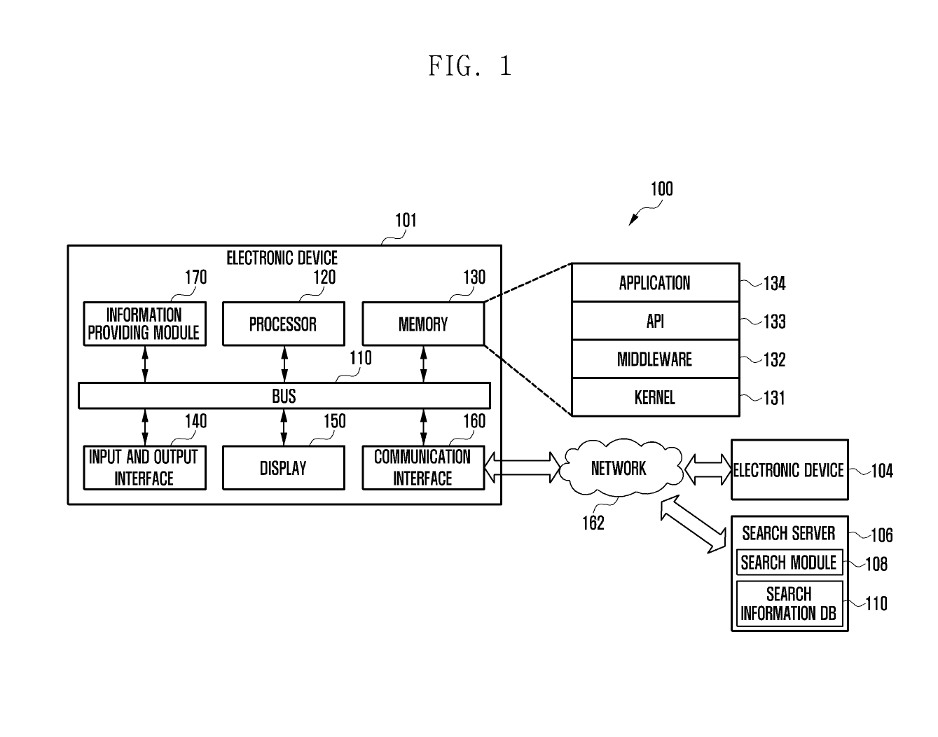

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication device.

Exemplary embodiments of the present disclosure are described with reference to the accompanying drawings in detail. Various changes may be made to the disclosure, and the disclosure may have various forms, such that exemplary embodiments will be illustrated in the drawings and described in detail. However, such various embodiments are not intended to limit the disclosure to the disclosed exemplary embodiment and it should be understood that the embodiment include all changes, equivalents, and substitutes within the spirit and scope of the disclosure. Throughout the drawings, like reference numerals refer to like components.

It will be understood that the expressions “comprises” and “may comprise” are used to specify presence of disclosed function, operation, component, etc., but do not preclude the presence of one or more functions, operations, components, etc. It will be further understood that the terms “comprises” or “has” when used in this specification, specify the presence of stated feature, number, step, operation, component, element, or a combination thereof but do not preclude the presence or addition of one or more other features, numbers, steps, operations, components, elements, or combinations thereof. In the present disclosure, the expression “and/or” is taken as specific disclosure of each and any combination of enumerated things. For example, A and/or B is to be taken as specific disclosure of each of A, B, and A and B.

As used herein, terms such as “first,” “second,” etc. are used to describe various components, however, it is obvious that the components should not be defined by these terms. For example, the terms do not restrict the order and/or importance of the corresponding components. The terms are used only for distinguishing one component from another component. For example, a first component may be referred to as a second component and likewise, a second component may also be referred to as a first component, without departing from the teaching of the inventive concept.

It will be understood that when an element or layer is referred to as being “on”, “connected to” or “coupled to” another element or layer, it can be directly on, connected or coupled to the other element or layer or intervening elements or layers is present. In contrast, when an element is referred to as being “directly on,” “directly connected to” or “directly coupled to” another element or layer, there are no intervening elements or layers present.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise.

Unless otherwise defined herein, all terms including technical or scientific terms used herein have the same meanings as commonly understood by those skilled in the art to which the present disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Examples of the electronic device include smartphone, table Personal Computer (PC), mobile phone, video phone, electronic book (e-book) reader, desktop PC, laptop PC, netbook computer, Personal Digital Assistant (PDA), Portable Multimedia Player (PMP), MP3 player, mobile medical appliance, camera, wearable device (e.g. a head-mounted device (HMD) such as electronic glasses, electronic clothing, electronic bracelet, electronic necklace, electronic appcessory, electronic tattoo, smartwatch, etc.

According to various embodiments, the electronic device is one of smart home appliances having operation support function. Examples of the smart electronic appliance as an electronic device include television, Digital Video Disk (DVD) player, audio player, refrigerator, air-conditioner, vacuum cleaner, electronic oven, microwave oven, laundry machine, air cleaner, set-to box, TV box (e.g. SAMSUNG HOMESYNC™, APPLE TV™, and GOOGLE TV™), game console, electronic dictionary, electronic key, camcorder, and electronic frame, etc.

According to various embodiments, examples of the electronic device include medical device (e.g. Magnetic Resonance Angiography (MRA), Magnetic Resonance Imaging (MRI), Computed Tomography (CT)), Navigation device, Global Positioning System (GPS) receiver, Event Data Recorder (EDR), Flight Data Recorder (FDR), car infotainment device, maritime electronic device (e.g. maritime navigation device and gyro compass), aviation electronic device (avionics), security device, vehicle head unit, industrial or home robot, Automatic Teller's Machine (ATM) of financial institution, Point Of Sales (POS), etc.

According to various embodiments, examples of the electronic device include furniture and building or structure having a communication function, electronic board, electronic signature receiving device, projector, and metering device (e.g. water, electric, gas, and electric wave metering devices). According to various embodiments, the electronic device is any combination of the aforementioned devices. According to various embodiments of the present disclosure, the electronic device is a flexible device. It is obvious to those skilled in the art that the electronic device is not limited to the aforementioned devices.

FIG. 1 depicts a network environment 100 including an electronic device 101 according to various embodiments of the present disclosure. Referring to FIG. 1, the electronic device 101 includes a bus 110, a processor 120, a memory 130, an input/output interface 140, a display 150, a communication interface 160 and an information providing module 170.

The bus 110 connects the aforementioned components to each other and is a circuit of exchanging signals (e.g. control messages) among the components.

For example, the processor 120 receives a command from any of the aforementioned components (e.g. memory 130, input/output interface 140, display 150, communication interface 160, and information providing module 170) through the bus 110, interprets the command, and executes operation or data processing according to the decrypted command.

The memory 130 stores the command or data received from the processor 120 or other components (e.g. input/output interface 140, display 150, communication interface 160, information providing module 170, etc.) or generated by the processor 120 or other components. The memory 130 stores program modules including kernel 131, middleware 132, Application Programming Interface (API) 133, applications 134, etc. Each programming module is implemented as software, firmware, hardware, and any combination thereof.

The kernel 131 controls or manages the system resources (e.g. bus 110, processor 120, and memory 130) for use in executing the operation or function implemented with the middleware 132, the API 133, or the application 134. The kernel 131 also provides an interface allowing the middleware 132, API 133, or application 134 to access the components of the electronic device 101 to control or manage.

The middleware 132 works as a relay of data communicated between the API 133 or application 134 and the kernel 131. The middle 132 executes control of the task requests from the applications 134 in such a way of assigning priority for use of the system resource (e.g. bus 110, processor 120, and memory 130) of the electronic device to at least one of the applications 134.

The API 133 is the interface for the applications 134 to control the function provided by the kernel 131 or the middleware 132 and includes at least one interface or function (e.g. command) for file control, window control, image control, or text control.

According to various embodiments, the applications 134 includes Short Messaging Service/Multimedia Messaging Service (SMS/MMS) application, email application, calendar application, alarm application, health care application (e.g. application of measuring quantity of motion or blood sugar level), and environmental information application (e.g. atmospheric pressure, humidity, and temperature applications). The application 134 is an application related to information exchange between the electronic device 101 and other external electronic device (e.g. electronic device 104). Examples of the information exchange application include a notification relay application for relaying specific information to the external electronic device and a device management application for managing the external electronic device.

For example, the notification relay application is provided with a function of relaying the alarm information generated by the other applications (e.g. SMS/MMS application, email application, health care application, and environmental information application) of the electronic device 101 to an external electronic device (e.g. electronic device 104). The notification relay application provides the user with the notification information received from an external electronic device (e.g. electronic device 104). The electronic device application manages (e.g. installs, deletes, and updates) the function of an external electronic device (e.g. turn-on/off of the electronic device 104 itself (or a part of it) or adjustment of the brightness (or resolution) of the display) which communicates with the electronic device 101 or the service (e.g. communication or messaging service) provided by the external electronic device or an application running on the external device.

According to various embodiments, the applications 134 includes an application designated according to the property (e.g. type) of an external electronic device (electronic device 104). If the external electronic device is the MP3 player, the applications 134 includes a music playback application. Similarly, if the external electronic device is a mobile medical appliance, the applications 134 includes a heal care application. According to various embodiments, the application 134 includes at least one of applications designated to the electronic device 101 or the applications received from the external electronic device (e.g. server 106 and electronic device 104).

The input/output interface 140 delivers the command or data input by the user through with an input/output device (e.g. sensor, keyboard, and touchscreen) to the processor 120, memory 130, communication interface 160, and/or information providing module 170 through the bus 110. For example, the input/output interface 140 provides the processor 120 with the data corresponding to the touch by the user on the touchscreen. The input/output interface 140 outputs the command or data (which is received from the processor 120, memory 130, communication interfaced 160, or the information providing module 170 through the bus 110) through the input/output device (e.g. speaker and display). For example, the input/out interface 140 outputs the voice data processed by the processor 120 to the user through the speaker.

The display 150 presents various informations (e.g. multimedia data and text data) to the user.

The communication interface 160 establishes a communication connection of the electronic device 101 with an external device (e.g. electronic device 104 and server 106). For example, the communication interface 160 connects to the network 162 through a wireless or wired link for communication with the external device. Examples of the wireless communication technology include wireless fidelity (Wi-Fi), BLUETOOTH (BT), Near Field Communication (NFC), Global Positioning System (GPS), and cellular communication technology (e.g. Long Term Evolution (LTE), LTE-Advanced (LTE-A), Code Division Multiple Access (CDMA), Wideband CDMA (WCDMA), Universal Mobile Telecommunication System (UMTS), Wireless-Broadband (WiBro), and General System for Mobile communications (GSM)). Examples of the wired communication technology include Universal Serial Bus (USB), High Definition Multimedia Interface (HDMI), Recommended Standard 232 (RS-232), and Plain Old Telephone Service (POTS).

According to various embodiments, the network 162 is a telecommunication network. The communication network includes at least one of a computer network, Internet, Internet of Things, and telephone network. According to various embodiments, the communication protocol between the electronic device 101 and an external device (e.g. transport layer protocol, data link layer protocol, and physical layer protocol) is supported by at least one of the applications 134, API 133, middleware 132, kernel 131, and communication interface 160.

According to various embodiments, the server 106 executes at least one of operations (or functions) implemented at the electronic device 101 to support the operation of the electronic device 101. According to various embodiments, the server 106 performs at least one of the operations (or functions) implemented on the electronic device 101, thereby supporting the electronic device 101. For example, the server 106 includes a search module 108 that supports an information providing module 170 implemented in the electronic device 101. For example, the search module 108 includes at least one of the components of the information providing module 170 performs (e.g., to execute) at least one of the operations of the information providing module 170. In addition, the server 106 includes a search information DB 112. The search information database (DB) 112 is a DB that the search module 108 uses to perform a search process.

The information providing module 170 processes at least part of the information obtained from other components (e.g., the processor 120, memory 130, input/output interface 140, or communication interface 160) and provides the processed information to the user in various modes. For example, the information providing module 170 controls at least part of the functions of the electronic device 101 so that the electronic device 101 can cooperate with other electronic devices (e.g., the electronic device 104 or the server 106) with or without the use of the processor 120.

According to various embodiments, at least one configuration of the information providing module 170 is included in the server 106, and at one operation implemented on the information providing module 170 is supported by the server 106. For example, a retrieval word extracting module of the processor 120 controls the communication interface 160 to transmit text information to extract retrieval words to the search server 106 through the network 162.

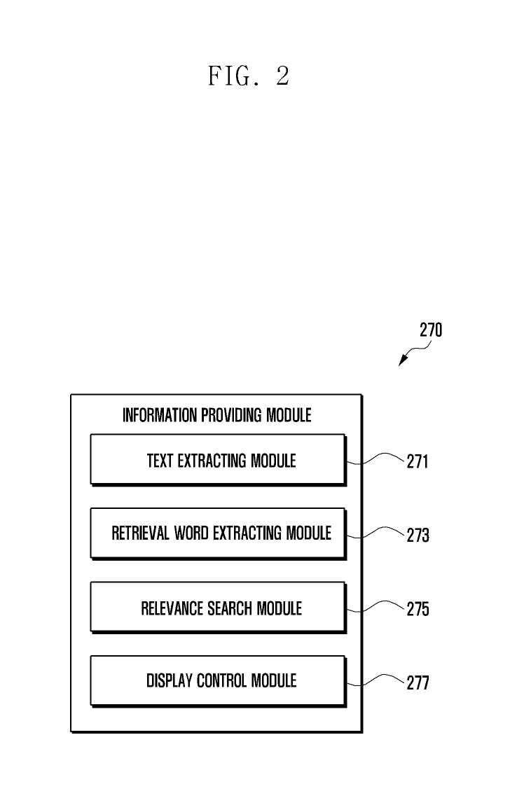

After receiving the text information, the search module 108 of the search server 106 extracts a retrieval word corresponding to a name entity, concept, etc. from the search information DB 110. The named entity means, for example, one, named, independent entity and refers to a noun indicating an object or a subject. The retrieval word includes at least one of the following: a keyword form and a phrase form. A detailed description about the information providing module 170 is provided as follows referring to FIGS. 2 to 9.

FIG. 2 depicts a schematic block diagram of an information providing module of an electronic device (e.g., an information providing module 170 of an electronic device 101 shown in FIG. 1) according to various embodiments of the present disclosure. Referring to FIG. 2, the information providing module 270 (e.g., the information providing module 170 shown in FIG. 1) includes a text extracting module 271, a retrieval word extracting module 273, a relevance search module 275 and a display control module 277. The information providing module 270 controls the text extracting module 271, retrieval word extracting module 273, relevance search module 275 and display control module 277.

The text extracting module 271 extracts text information from data displayed as a text-based application is executed. The text information is extracted from part or all of the text-based application. For example, the text information is a subject or body of an email, recently transmitted or received message information through a message application, title and body content without advertisements of the content that a web browser has recently displayed, etc.

The retrieval word extracting module 273 extracts retrieval words from the text information items extracted by the text extracting module 271. In order to extract retrieval words, the retrieval word extracting module 273 transmits text information to extract retrieval words to the search server 106 through a communication module 220. After receiving the text information, the search module 108 of the search server 106 extracts a retrieval word corresponding to a named entity, concept. etc. from the search information DB 112. The named entity means, for example, one, named, independent entity and also refers to a noun indicating an object or a subject. The retrieval word is formed to have a keyword form and/or a phrase form. The search information DB 112 includes a knowledge-based DB such as WIKIPEDIA, etc., biographical dictionaries, etc. The search module 108 of the search server 106 transmits extracted retrieval words to the electronic device 101 through the network 162. As various embodiments for extracting retrieval words, the retrieval word extracting module 273 extracts, as a retrieval word, a text (e.g., a word, phrase, etc.) with the highest frequency of display from among the extracted text information. The retrieval word extracting module 273 also extracts a retrieval word by determining the similarity between a text corresponding to a named entity, concept, etc., selected by the search information DB 112, and extracted text information. The named entity means, for example, one, named, independent entity and also refers to a noun indicating an object or a subject.

The relevance search module 275 searches for information related to first information by a retrieval word transmitted from the search server 106. The first information is data displayed as a text-based application is executed. The information related to the first information contains second information and third information. The second information is information searched by a retrieval word. The third information is information searched based on the original text of the first information.

The relevance search module 275 obtains the second information and/or third information from a DB that provides the information related to the first information. The DB is a DB that includes the search information DB 112 of the search server 106 and the memory of the electronic device 101. The search information DB 112 includes information transmitted from various Content Service Providers (CSPs). The relevance search module 275 temporarily arrange or store the searched second and/or third information in the memory (e.g., a frame buffer) based on various standards, such as the preference of CSP, the extent of including a keyword, phrase, etc. of the first information.

The relevance search module 275 creates and manages a mapping table by using the second information stored in the buffer and retrieval words that have been used to search the second information. The relevance search module 275 stores the mapping table in the buffer.

The display control module 277 controls the display 150 to detect a user's selection to objects and to display the second information stored in the buffer. The display control module 277 also controls the display 150 to display the third information stored in the buffer. The display control module 277 also controls the display 150 to display the second information and the third information together.

The display control module 277 controls the display 150 to highlight and display objects corresponding to retrieval words mapped to the second information on the first information displayed as a text-based application is executed. The process of highlighting and displaying objects includes any process for displaying objects with an emphasizing effect, such as a shading, underlining, thickening, tilting, etc. As an example, the display control module 227 controls the display 150 to display objects, corresponding to retrieval words mapped to the second information, on a user interface, such as a list form, a list of tabs classified based on a standard.

The electronic device according to various embodiments of the present disclosure includes: a display, a memory and an information providing module. The display displays first information as a text-based application is executed and second information related to the first information. The memory includes: a mapping table where keywords and phrases, used to obtain second information as relevant information related to the first information, are mapped to the second information and the mapped results are stored, and a database (DB) for obtaining the second information. The information providing module controls a communication module to search for the second information from an external DB. The information providing module: displays the first information; extracts one or more retrieval words in a form of keyword and/or a form of phrase from the first information; obtains the second information as relevant information related to the first information by using the one or more extracted retrieval words; emphasizes objects corresponding to the one or more retrieval words on the first information; and sets to display, when detecting the selection of at least one from the emphasized objects, the second information including the selected objects.

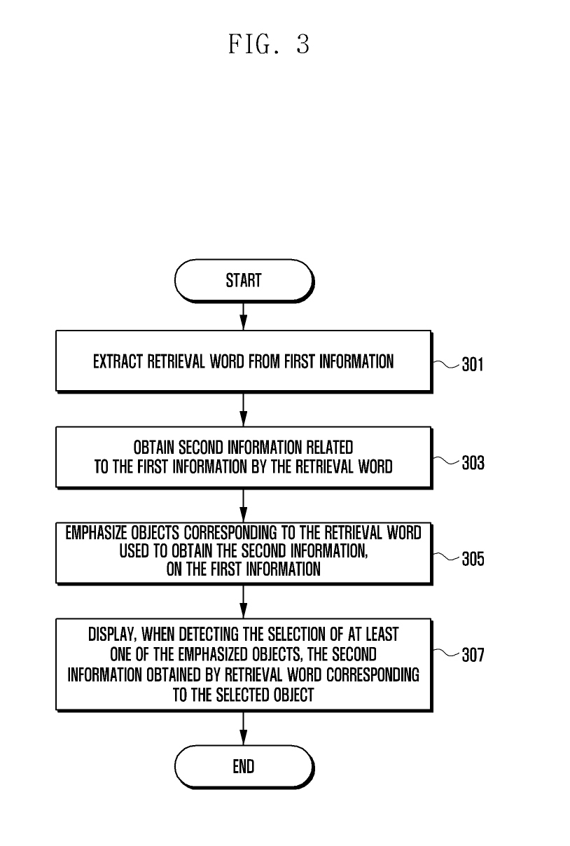

FIG. 3 is a flow diagram illustrating a method of providing relevant information by an electronic device according to various embodiments of the present disclosure.

Referring to FIG. 3, in operation 301, the information providing module 270 extracts retrieval words in a form of keyword and/or a form of phrase from text information items extracted from the first information. The extracted text information is part or all of information including text in the first information displayed as a text-based application is executed. The information providing module 270 transmits text information to an external search server 106 through the communication interface 160 so that the server 106 can extract retrieval words.

When the search module 108 of the search server 106 receives the text information, it extracts a retrieval word corresponding to a named entity, concept, etc. from the search information DB 112. The named entity means, for example, one, named, independent entity and also refers to a noun indicating an object or a subject. The retrieval word includes a keyword form and/or a phrase form. The search information DB 112 includes a knowledge-based DB such as WIKIPEDIA, etc., biographical dictionaries, etc. The search module 108 of the search server 106 transmits extracted retrieval words to the information providing module 270.

In operation 303, the information providing module 270 obtains information related to first information by a retrieval word transmitted from the search server 106. The first information is data displayed as a text-based application is executed. The information related to the first information contains second information and third information. The second information is information searched by a retrieval word. The third information is information searched based on the original text of the first information. The information providing module 270 obtains the second information and/or third information from a DB that provides information related to the first information.

The DB is a DB that includes the search information DB 112 of the search server 106 and the memory 130 of the electronic device 101. The search information DB 112 includes information transmitted from various Content Service Providers (CSPs). The relevance search module 275 temporarily arranges or stores the searched second and/or third information in the memory based on various standards, such as the preference of CSP, the extent of including a keyword, phrase, etc. of the first information.

In operation 305, the information providing module 270 controls the display 150 to highlight and display objects, corresponding to retrieval words mapped to the second information, on the first information displayed as a text-based application is executed. The process of highlighting and displaying objects includes a process for displaying objects with an emphasizing effect, such as a shading, underlining, thickening, tilting, etc. As an example, the information providing module 270 controls the display 150 to display objects, corresponding to retrieval words mapped to the second information, on a user interface, such as a list form, a list of tabs classified based on a standard.

In operation 307, the information providing module 270 detects a user's selection to an object emphasized on the first information or to an object displayed on the user interface. In certain embodiments, the information providing module 270 controls the display 150 to display the second information mapped to a retrieval word corresponding to the object. The information providing module 270 also controls the display 150 to display the third information.

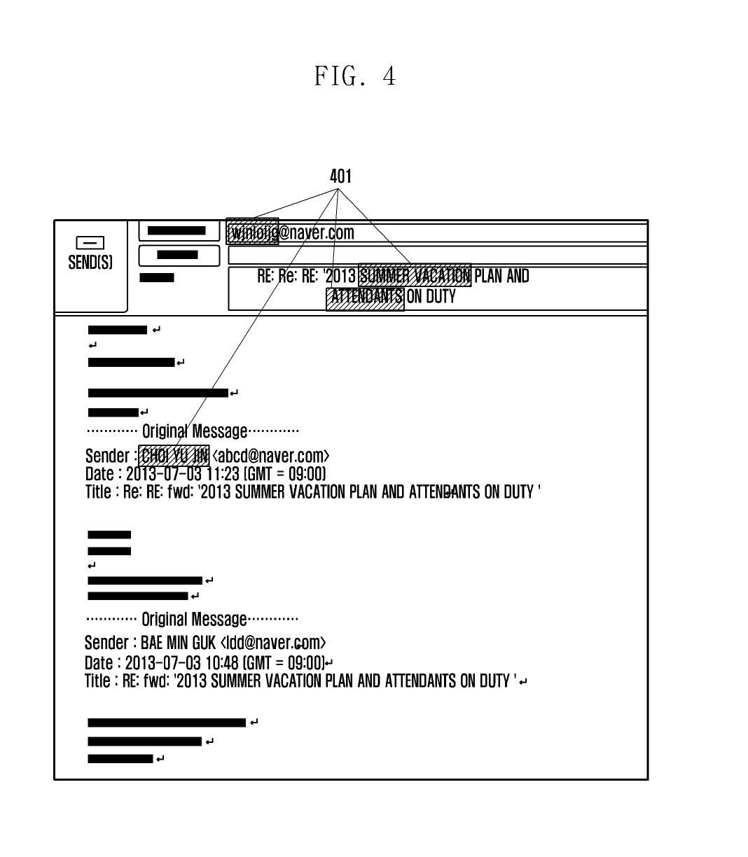

FIG. 4 is a diagram that describes a process of emphasizing keywords and phrases containing relevant information in an electronic device according to various embodiments of the present disclosure.

Referring to FIG. 4, the information providing module 270 extracts text information from data displayed as a text-based application, e.g., an email application, is executed. As shown in FIG. 4, the data displayed as an email application is executed is first information. The text information is a sender and a recipient of an email, subject and body of an email, etc. The information providing module 270 transmits text information to a search server 106 through the communication interface 160 so that the server 106 can extract retrieval words. When the search module 108 of the search server 106 receives the text information, it extracts a retrieval word corresponding to a named entity, concept, etc. from the search information DB 112. The named entity means, for example, one, named, independent entity and also refers to a noun indicating an object or a subject. The search information DB 112 is a knowledge-based DB such as WIKIPEDIA, etc., biographical dictionaries, etc. The retrieval word includes a keyword form and/or a phrase form.

The information providing module 270 extracts retrieval words from an email application, based on a plurality of standards. Examples of the retrieval words in an email application are an email subject, email sender, email recipient, etc. in the extracted text information. Conventional email applications provide a function that sorts and displays subjects, senders, recipients, etc., and a function that displays only information that the user requested and searched the email applications for by using the subjects, senders, recipients, etc. Therefore, the email subject, email sender, email recipient, etc. for an email application are retrieval words for search the search information DB 112. In addition, the content of an email as text information extracted in an email application also includes retrieval words. For example, words, phrases, etc., frequently shown in the content of emails, serve as retrieval words. In certain embodiments, a user's interested topic is analogized from the words, phrases, etc., frequently shown in the content of emails.

The search module 108 of the search server 106 transmits the extracted retrieval words to the information providing module 270 through the network 162.

The information providing module 270 obtains the second information related to the first information by using retrieval words. The information providing module 270 creates a mapping table by mapping the obtained second information to the retrieval words and manages the mapping table. The information providing module 270 creates, stores and manages the second information obtained and the created mapping table in the buffer. The information providing module 270 controls the display 150 to highlight and display objects 401 corresponding to retrieval words mapped to the second information obtained, on the first information, where the mapping results are stored. In the embodiment of FIG. 4, examples of the objects 401 corresponding to at least one of the emphasized keyword and phrases are a recipient's ID, i.e., ‘winloiig,’ the subject, i.e., ‘Summer vacation.’ ‘attendant,’ and a sender's name. i.e., ‘CHOI Yu-Jin.’

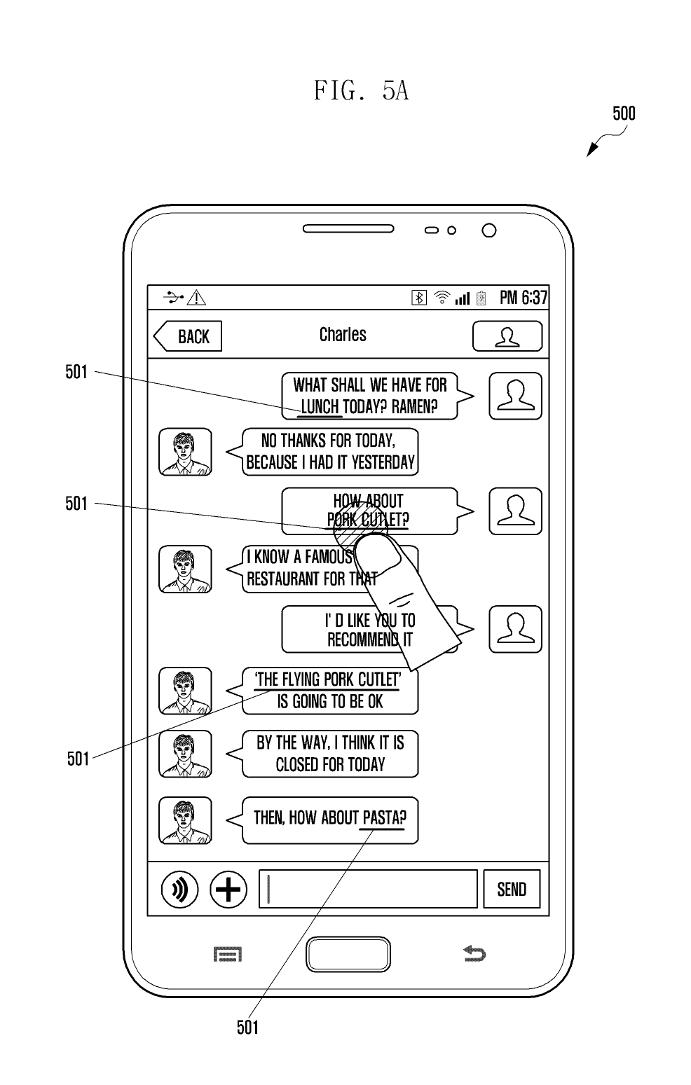

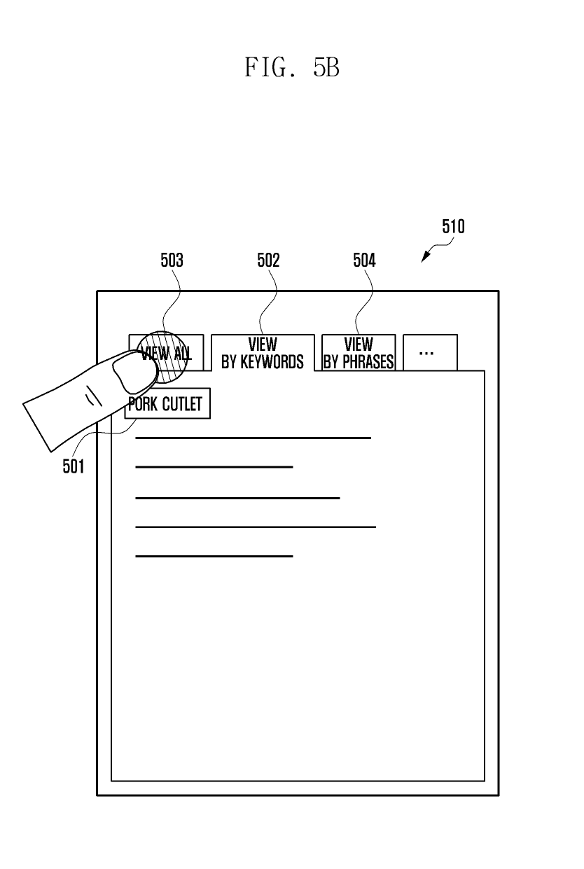

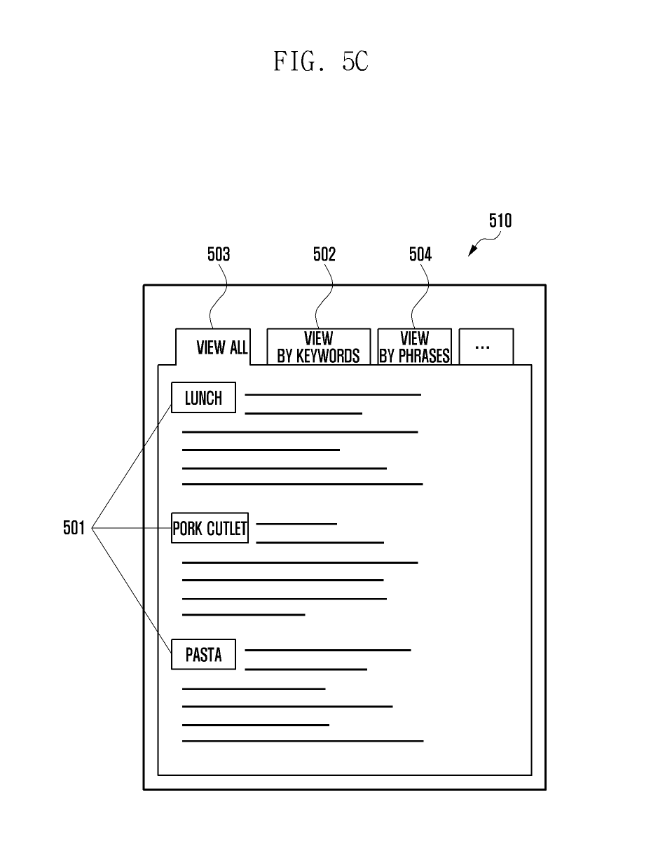

FIGS. 5A to 5C are diagrams that provide relevant information according to various embodiments of the present disclosure.

More specifically, FIG. 5A depicts a screen showing a chat window 500 of a chat application, one of the text-based applications. The chat window 500 displays conversations between two or more chatters. On the chat window 500, particular objects of the conversations, ‘lunch,’ ‘Pork cutlet,’ ‘The Flying Port Cutlet,’ and ‘Pasta,’ are emphasized and displayed. The processes of emphasizing and displaying particular objects on the chat window 500 are described as follows. The information providing module 270 extracts text information from data displayed as a chat application, one of the text-based applications, is executed. The information providing module 270 extracts chat content, other chatter's names, etc. as text information on the chat window 500. The information providing module 270 transmits the text information to the search server 106 through the communication interface 160 so that the server 106 can extract retrieval words. The information providing module 270 extracts, as retrieval words, part or all of text information from the chat window 500 that have a form of keyword and/or a form of phrase and are repeatedly and frequently shown on the chat window 500. Examples of the retrieval words extracted from the text information are ‘lunch,’ ‘Pork cutlet,’ ‘The Flying Port Cutlet,’ ‘Pasta,’ etc.

The search module 108 of the search server 106 transmits the extracted retrieval words to the information providing module 270 through the network 162.

The information providing module 270 obtains the second information related to the first information by using the retrieval words. The information providing module 270 creates a mapping table by mapping the obtained second information to the retrieval words and manages the mapping table. The information providing module 270 creates, stores and manages the second information obtained and the created mapping table in the buffer. The information providing module 270 controls the display 150 to highlight and display objects 501 corresponding to retrieval words mapped to the second information obtained, on the first information, where the mapping results are stored. In certain embodiments, the information providing module 270 controls the display 150 to emphasize objects 501 on the first information or also to display objects 501 with the second information on a list or on a list of tabs as shown in FIG. 5B.

As shown in FIG. 5A, the information providing module 270 controls the display 150 to detect one of the highlighted objects selected by the user, ‘Pork cutlet,’ and to display only the second information corresponding to the selected object ‘Pork cutlet.’ The information providing module 270 controls the display 150 to display the second information to which a keyword corresponding to an object 501, ‘Pork cutlet,’ is mapped to and that is stored in the buffer.

Displaying the second information is implemented in various methods. As various embodiments, as shown in FIG. SB, the second information is displayed in a form of tab list. The information providing module 270 displays the second information of a keyword corresponding to an object 501, ‘Pork cutlet,’ on a list of tabs. The tabs are classified based on various standards, such as view by keywords 502, view by phrases 504, view all 503, etc. Since the information providing module 270 detected a user's selection to ‘Port cutlet’ as shown in FIG. 5A, it controls the display 150 to display only the second information related to ‘Pork cutlet’ on the view by keywords 502. When the information providing module 270 detects a user's selection a tab of view all 503 as shown in FIG. 5B, it controls the display 150 to display the second information items, to which retrieval words corresponding to all the objects 501 highlighted on the first information are mapped, where the mapping result are stored, on the tab of view all 503 along with the retrieval words, as shown in FIG. 5C.

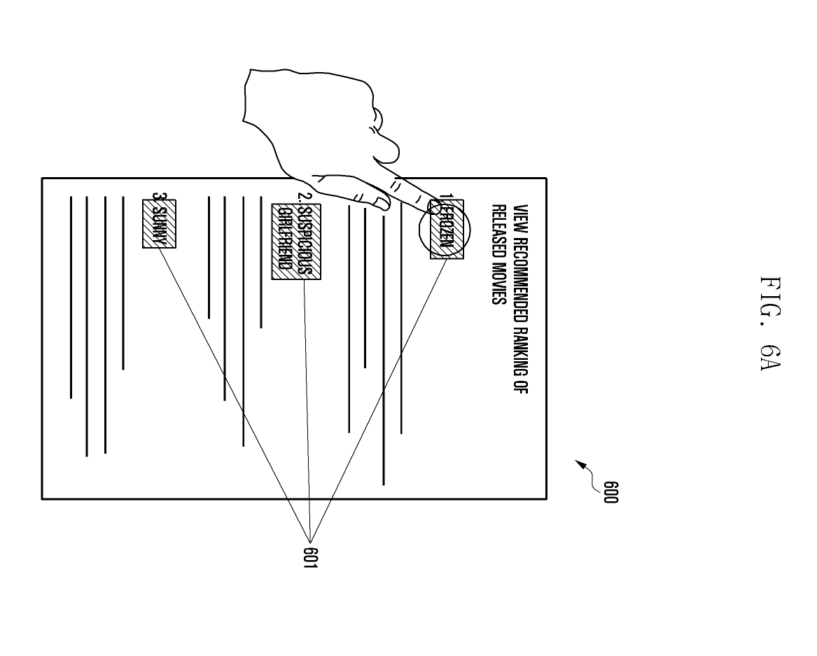

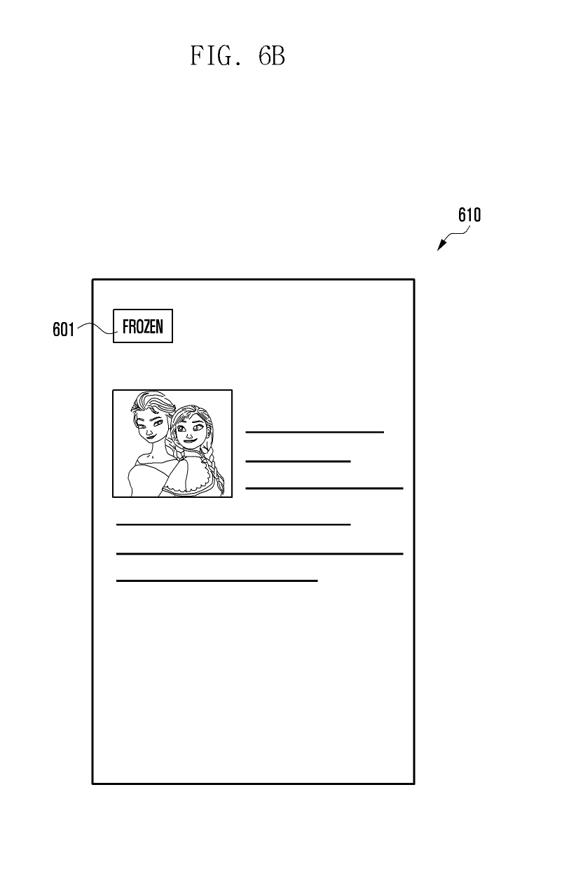

FIGS. 6A and 6B are diagrams that provide relevant information according to various embodiments of the present disclosure.

More specifically, FIG. 6A depicts a screen showing a document 600 according to the execution of a document application, one of the text-based applications. The document 600 is a text document that the user has written or is writing, a document received from a web browser or an external electronic device, etc. On the document 600, particular objects. ‘Frozen,’ ‘Suspicious Girlfriend’ and ‘Sunny’ are emphasized and displayed. The processes of emphasizing and displaying particular objects on the document 600 are described as follows.

The information providing module 270 extracts text information from data displayed as a document application, one of the text-based applications, is executed. The information providing module 270 extracts the title, content, etc. of the document 600 as text information from the document 600. The information providing module 270 transmits the text information to the search server 106 through the communication interface 160 so that the server 106 can extract retrieval words. The information providing module 270 extracts, as retrieval words, a keyword and/or a phrase repeatedly and frequently shown on the document 600 from the text information extracted from the document 600. Examples of the retrieval words are ‘Frozen.’ ‘Suspicious Girlfriend,’ ‘Sunny,’ etc.

The search module 108 of the search server 106 transmits the extracted retrieval words to the information providing module 270 through the network 162. The information providing module 270 obtains the second information related to the first information by using the retrieval words. The information providing module 270 creates a mapping table by mapping the obtained second information to the retrieval words and manages the mapping table. The information providing module 270 creates, stores and manages the second information obtained and the created mapping table in the buffer. The information providing module 270 controls the display 150 to highlight and display objects 601 corresponding to retrieval words mapped to the second information obtained, on the first information, where the mapping results are stored. In certain embodiments, the information providing module 270 controls the display 150 to emphasize objects 601 on the first information or also to display objects 601 with the second information on a list or on a list of tabs as shown in FIG. 6B.

The information providing module 270 detects a user's selection to one of the highlighted objects, ‘Frozen’ 601. The information providing module 270 controls the display 150 to display the second information to which a keyword corresponding to an object 601, ‘Frozen.’ is mapped to and that is stored in the buffer. Displaying the second information is implemented in various methods. As various embodiments, as shown in FIG. 6B, the information providing module 270 controls the display 150 to display only the second information containing a keyword corresponding to the object 601, ‘Frozen.’

The method according to various embodiments of the present disclosure includes: displaying first information; extracting one or more retrieval words in a form of keyword and/or a form of phrase from the first information; obtaining the second information as relevant information related to the first information by using the one or more extracted retrieval words; emphasizing objects corresponding to the one or more retrieval words on the first information; and displaying, when detecting the selection of at least one from the emphasized objects, the second information including the selected objects.

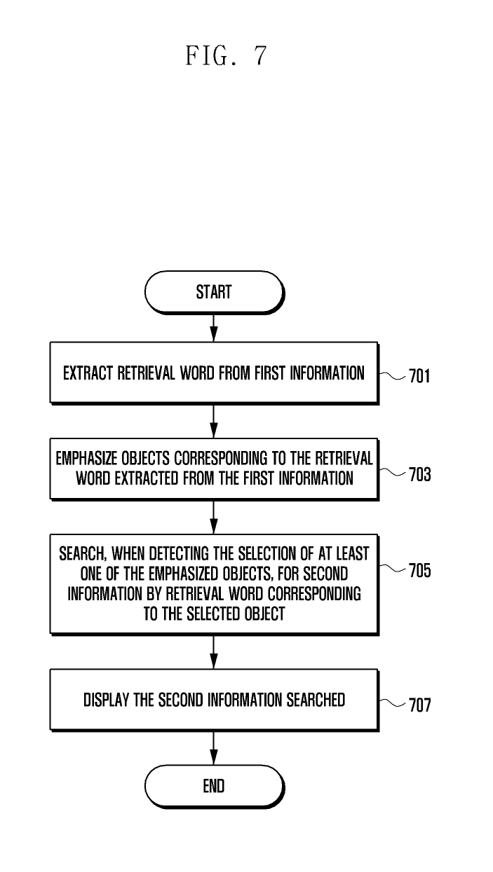

FIG. 7 is a flow diagram illustrating a method of providing relevant information by an electronic device according to various embodiments of the present disclosure.

In operation 701, the information providing module 270 performs a function for extracting retrieval words that have a form of keyword and/or a form of phrase from items of the text information extracted from the first information. The extracted text information is part or all of the information including text in the first information displayed as a text-based application is executed. The information providing module 270 transmits text information to an external search server 106 through the communication interface 160 so that the server 106 can extract retrieval words. After receiving the text information, the search module 108 of the search server 106 extracts a retrieval word corresponding to a named entity, concept, etc. from the search information DB 112. The named entity means, for example, one, named, independent entity and also refers to a noun indicating an object or a subject. The retrieval word is formed to have a keyword form and/or a phrase form. The search information DB 112 includes a knowledge-based DB such as WIKIPEDIA, etc., biographical dictionaries, etc. The search module 108 of the search server 106 transmits extracted retrieval words to the information providing module 270.

In operation 703, the information providing module 270 controls the display 150 to highlight and display objects corresponding to the retrieval words, on data displayed as a text-based application is executed, i.e., on the first information. The process of highlighting and displaying objects includes any process for displaying objects with an emphasizing effect, such as a shading, underlining, thickening, tilting, etc. As an example, the information providing module 270 controls the display 150 to display objects corresponding to retrieval words on a list or to display objects corresponding to retrieval words on a user interface, such as a list of tabs classified based on a standard.

In operation 705, the information providing module 270 detects a user's selection to an object emphasized on the first information or to an object displayed on the user interface. In certain embodiments, the information providing module 270 searches for information related to the first information from the memory 130 of the electronic device by the extracted retrieval word. The first information is data displayed as a text-based application is executed. The information related to the first information contains second information and third information. The second information is information searched by a retrieval word of a keyword form or a phrase form. The third information is information searched based on the original text of the first information.

In operation 707, the information providing module 270 controls the display 150 to display the second information that is searched from the memory 130 by a retrieval word corresponding to the object. The information providing module 270 also controls the display 150 to display the third information.

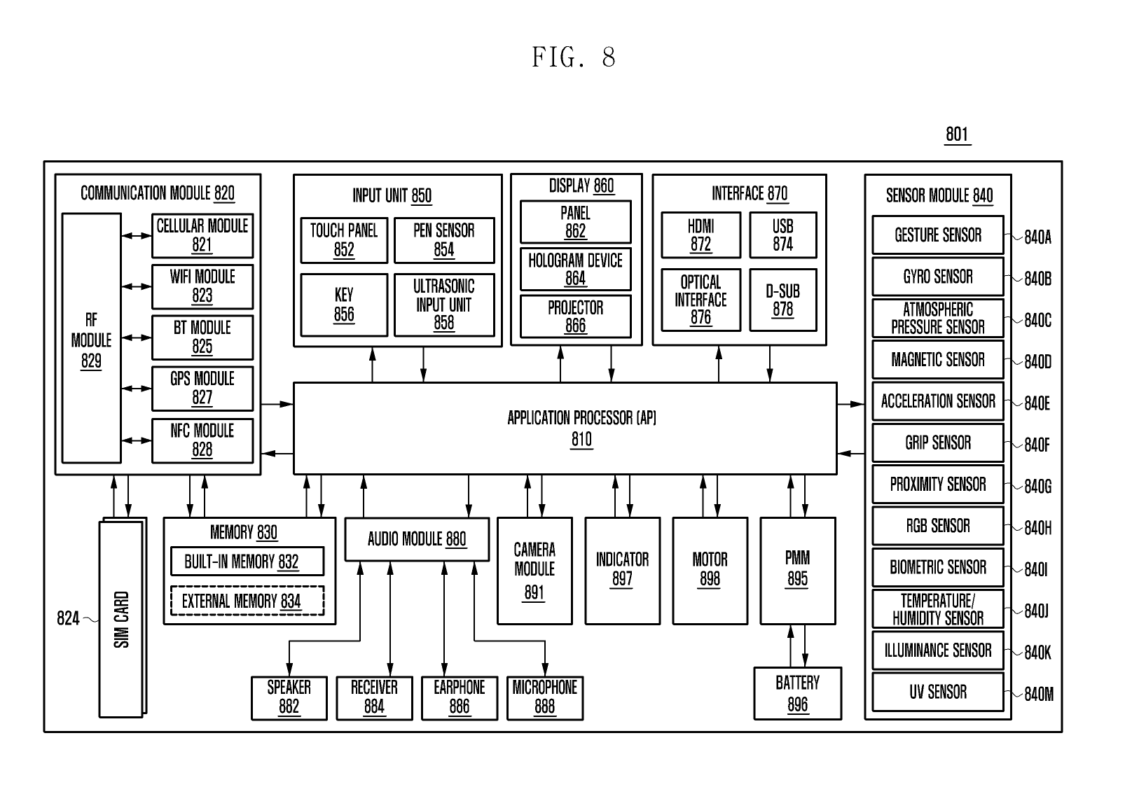

FIG. 8 is a block diagram illustrating a configuration of the electronic device according to various embodiments of the present disclosure. The electronic device 801 is of the whole or a part of the electronic device 101. Referring to FIG. 8, the electronic device 801 include an Application Processor (AP) 810, a communication module 820, a Subscriber Identity Module (SIM) card 824, a memory 830, a sensor module 840, an input device 850, a display 860, an interface 870, an audio module 880, a camera module 891, a power management module 895, a battery 896, an indicator 897, and a motor 898.

The AP 810 operates an Operating System (OS) and/or application programs to control a plurality of hardware and/or software components connected to the AP 810 and perform data-processing and operations on multimedia data. For example, the AP 810 is implemented in the form of System on Chip (SoC). According to various embodiments, the AP 810 includes a Graphic Processing Unit (GPU) (not shown).

The communication module 820 (e.g. communication interface 160) performs data communication with other electronic devices (e.g. electronic device 104 and server 106) through a network. According to various embodiments, the communication module 820 includes a cellular module 821, a Wi-Fi module 823, a BT module 825, a GPS module 827, an NFC module 828, and a Radio Frequency (RF) module 829.

The cellular module 821 is responsible for voice and video communication, text messaging, and Internet access services through a communication network (e.g. LTE. LTE-A, CDMA, WCDMA, UMTS. WiBro, and GSM networks). The cellular module 821 performs identification and authentication of electronic devices in the communication network using the SIM card 824. According to various embodiments, the cellular module 821 performs at least one of the functions of the AP 810. For example, the cellular module 821 performs at least a part of the multimedia control function.

According to various embodiments, the cellular module 821 includes a Communication Processor (CP). The cellular module 821 is implemented in the form of SOC. Although the cellular module 821 (e.g. communication processor), the memory 830, and the power management module 895 are depicted as independent components separated from the AP 810, the present disclosure is not limited thereto but is embodied in a way that the AP includes at least one of the components (e.g. cellular module 821).

According to various embodiments, each of the AP 810 and the cellular module 821 (e.g. communication processor) loads a command or data received from at least one of the components on a non-volatile or volatile memory and processes the command or data. The AP 810 or the cellular module 821 stores the data received from other components or generated by at least one of other components in the non-volatile memory.

Each of the Wi-Fi module 823, the BT module 825, the GPS module 827, and the NFC module 828 includes a processor for processing the data it transmits or receives. Although the cellular module 821, the Wi-Fi module 823, the BT module 825, the GPS module 827, and the NFC module 828 are depicted as independent blocks; at least two of them (e.g. communication processor corresponding to the cellular module 821 and Wi-Fi processor corresponding to the Wi-Fi module 823) are integrated in the form of SoC.

The RF module 829 is responsible for data communication, e.g. transmitting or receiving RF signals. Although not depicted, the RF module 829 includes a transceiver, a Power Amp Module (PAM), a frequency filter, and a Low Noise Amplifier (LNA). The RF module 829 also includes the elements for transmitting or receiving electric wave in free space, e.g. conductor or conductive wire. Although FIG. 8 is directed to the case where the Wi-Fi module 823, the BT module 825, the GPS module 827, and the NFC module 828 are sharing the RF module 829, the present disclosure is not limited thereto but is embodied in a way that at least one of the Wi-Fi module 823, the BT module 825, the GPS module 827, and the NFC module 828 transmits or receives RF signals an independent RF module.

The SIM card 824 is designed so as to be inserted into a slot formed at a predetermined position of the electronic device. The SIM card 824 stores unique identity information (e.g. Integrated Circuit Card Identifier (ICCID)) or subscriber information (e.g. International Mobile Subscriber Identity (IMSI)).

The memory 830 (e.g. memory 130) includes at least one of the internal memory 832 and an external memory 834. The internal memory 832 includes at least one of a volatile memory (e.g. Dynamic Random Access Memory (DRAM), Static RAM (SRAM), Synchronous Dynamic RAM (SDRAM) or a non-volatile memory (e.g. One Time Programmable Read Only Memory (OTPROM), Programmable ROM (PROM), Erasable and Programmable ROM (EPROM), Electrically Erasable and Programmable ROM (EEPROM), mask ROM, flash ROM, NAND flash memory, and NOR flash memory)

According to various embodiments, the internal memory 832 is a Solid State Drive (SSD). The external memory 834 is a flash drive such as Compact Flash (CF), Secure Digital (SD), micro-SD, Mini-SD, extreme Digital (xD), and Memory Stick. The external memory 834 is connected to the electronic device 801 through various interfaces functionally. According to various embodiments, the electronic device 801 includes a storage device (or storage medium) such as hard drive.

The sensor module 840 measures physical quantity or checks the operation status of the electronic device 801 and converts the measured or checked information to an electric signal. The sensor module 840 includes at least one of gesture sensor 840A, Gyro sensor 840B, barometric sensor 840C, magnetic sensor 840D, acceleration sensor 840E, grip sensor 840F, proximity sensor 840G, color sensor 840H (e.g. Red, Green, Blue (RGB) sensor), bio sensor 840I, temperature/humidity sensor 840J, illuminance sensor 840K, and Ultra Violet (UV) sensor 840M. The sensor module 840 includes E-nose sensor (not shown), Electromyography (EMG) sensor (not shown), Electroencephalogram (EEG) sensor (not shown), Electrocardiogram (ECG) sensor (not shown), Infrared (IR) sensor (not shown), iris sensor (not shown), and fingerprint sensor (not shown). The sensor module 840 further includes a control circuit for controlling at least one of the sensors included therein.

The input device 850 includes a touch panel 852, a (digital) pen sensor 854, keys 856, and an ultrasonic input device 858. The touch panel 852 is one of capacitive, resistive, infrared, microwave type touch panel. The touch panel 852 includes a control circuit. In the case of the capacitive type touch panel, it is possible to detect physical contact or approximation. The touch panel 852 further includes a tactile layer. In certain embodiments, the touch panel 852 provides the user with haptic reaction.

The (digital) pen sensor 854 is implemented with a sheet with the same or similar way as touch input of the user or a separate recognition sheet. The keys 856 include physical buttons, optical key, and keypad. The ultrasonic input device 858 is a device capable of checking data by detecting sound wave through a microphone 888 and is implemented for wireless recognition. According to various embodiments, the electronic device 801 receives the user input made by means of an external device (e.g. computer or server) connected through the communication module 820.

The display 860 (e.g. display module 150) includes a panel 862, a hologram device 864, and a projector 866. The panel 862 is a Liquid Crystal Display (LCD) panel or an Active Matrix Organic Light Emitting Diodes (AMOLED) panel. The panel 862 is implemented so as to be flexible, transparent, and/or wearable. The panel 862 is implemented as a module integrated with the touch panel 852. The hologram device 864 presents 3-dimensional image in the air using interference of light. The projector 866 projects an image to a screen. The screen is placed inside or outside the electronic device. According to various embodiments, the display 860 includes a control circuit for controlling the panel 862, the hologram device 864, and the projector 866.

The interface 870 includes a High-Definition Multimedia Interface (HDMI) 872, a Universal Serial Bus (USB) 874, an optical interface 876, and a D-subminiature (D-sub) 878. The interface 870 includes the communication interface 160 as shown in FIG. 1. Additionally or alternatively, the interface 870 includes a Mobile High-definition Link (MHL) interface, a SD/MMC card interface, and infrared Data Association (irDA) standard interface.

The audio module 880 converts sound to electric signal and vice versa. At least a part of the audio module 880 is included in the input/output interface 140 as shown in FIG. 1. The audio module 880 processes the audio information input or output through the speaker 882, the receiver 884, the earphone 886, and the microphone 888.

The camera module 891 is a device capable of taking still and motion pictures and, according to various embodiments, includes at least one image sensor (e.g. front and rear sensors), a lens (not shown), and Image Signal Processor (ISP) (not shown), and a flash (e.g. LED or xenon lamp) (not shown).

The power management module 895 manages the power of the electronic device 801. Although not shown, the power management module 895 includes a Power Management Integrated Circuit (PMIC), a charger Integrated Circuit (IC), a battery, and a battery or fuel gauge.

The PMIC is integrated into an integrated circuit or SoC semiconductor. The charging is classified into wireless charging and wired charge. The charger IC charges the battery and protects the charger against overvoltage or overcurrent. According to various embodiments, the charger IC includes at least one of wired charger and wireless charger ICs. Examples of the wireless charging technology includes resonance wireless charging and electromagnetic wave wireless charging, and there is a need of extra circuit for wireless charging such as coil loop, resonance circuit, and diode.

The battery gauge measures the residual power of the battery 896, charging voltage, current, and temperature. The battery 896 stores or generates power and supplies the stored or generated power to the electronic device 801. The battery 896 includes a rechargeable battery or a solar battery.

The indicator 897 displays operation status of the electronic device 801 or a part of the electronic device, booting status, messaging status, and charging status. The motor 898 converts the electronic signal to mechanical vibration. Although not shown, the electronic device 801 includes a processing unit (e.g. GPU) for supporting mobile TV. The processing unit for supporting the mobile TV is able to processing the media data abiding by the broadcast standards such Digital Multimedia Broadcasting (DMB), Digital Video Broadcasting (DVB), and media flow.

As described above, the electronic device operating method and apparatus of the present disclosure is capable of providing diverse screen displays in adaptation to various conditions to implement optimal environment for utilizing the electronic device, resulting in improvement of user convenience. Also, the electronic device operating method and apparatus of the present disclosure is advantageous in terms of facilitating navigation between folders by sorting the folders by hierarchical level.

The above enumerated components of the electronic device of the present disclosure may be implemented into one or more parts, and the names of the corresponding components may be changed depending on the kind of the electronic device. The electronic device of the present disclosure includes at least one of the aforementioned components with omission or addition of some components. The components of the electronic device of the present disclosure may be combined selectively into an entity to perform the functions of the components equally as before the combination.

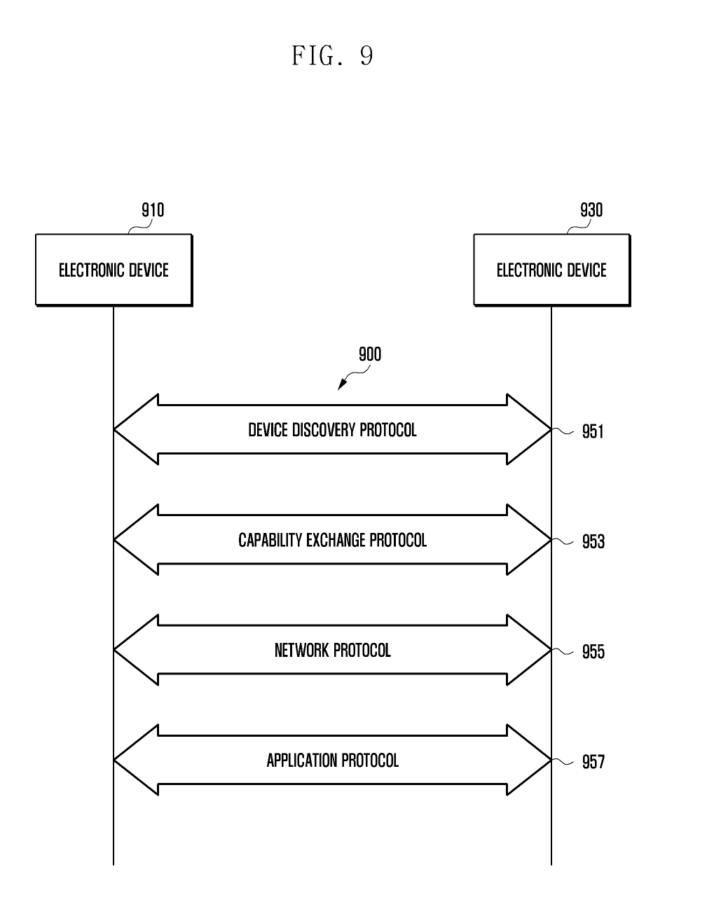

FIG. 9 illustrates communication protocols 900 between a plurality of electronic devices (e.g., an electronic device 910 and an electronic device 930) according to various embodiments.

Referring to FIG. 9, for example, the communication protocols 900 includes a device discovery protocol 951, a capability exchange protocol 953, a network protocol 955, and an application protocol 957.

According to various embodiments, the device discovery protocol 951 is a protocol by which the electronic devices (e.g., the electronic device 910 and the electronic device 930) detect external devices capable of communicating with the electronic devices, or connect with the detected external electronic devices. For example, the electronic device 910 (e.g., the electronic device 101) detects the electronic device 930 (e.g., the electronic device 104) as an electronic device capable of communicating with the electronic device 910 through communication methods (e.g., WiFi, BT, USB, or the like) that are available in the electronic device 910, by using the device discovery protocol 951. In order to connect with the electronic device 930 for communication, the electronic device 910 obtains and stores identification information on the detected electronic device 930 by using the device discovery protocol 951. The electronic device 910 initiates the communication connection with the electronic device 930, for example, based on at least the identification information.

According to various embodiments, the device discovery protocol 951 is a protocol for authentication between a plurality of electronic devices. For example, the electronic device 910 performs authentication between the electronic device 910 and the electronic device 930 based on at least communication information {e.g., Media Access Control (MAC), Universally Unique Identifier (UUID), Subsystem Identification (SSID), Internet Protocol (IP) address} for connection with the electronic device 930.

According to various embodiments, the capability exchange protocol 953 is a protocol for exchanging information related to service functions that can be supported by at least one of the electronic device 910 or the electronic device 930. For example, the electronic device 910 and the electronic device 930 exchange information on service functions which are currently supported by each electronic device with each other through the capability exchange protocol 953. The exchangeable information includes identification information indicating a specific service among a plurality of services supported by the electronic device 910 and the electronic device 930. For example, the electronic device 910 receives identification information for a specific service provided by the electronic device 930 from the electronic device 930 through the capability exchange protocol 953. In certain embodiments, the first electronic device 910 determines whether the electronic device 910 can support the specific service, based on the received identification information.

According to various embodiments, the network protocol 955 is a protocol for controlling the data flow which is transmitted and received between the electronic devices (e.g., the electronic device 910 and the electronic device 930) connected with each other for communication, for example, in order to provide interworking services. For example, at least one of the electronic device 910 or the electronic device 930 performs the error control or the data quality control, by using the network protocol 955. The network protocol 955 determines the transmission format of data transmitted and received between the electronic device 910 and the electronic device 930. In addition, at least one of the electronic device 910 or the electronic device 930 manages a session (e.g., session connection or session termination) for the data exchange between them, by using the network protocol 955.

According to various embodiments, the application protocol 957 is a protocol for providing a procedure or information to exchange data related to services which are provided to the external devices. For example, the electronic device 910 (e.g., the electronic device 101) provides services to the electronic device 930 (e.g., the electronic device 104 or the server 106) through the application protocol 957.

According to various embodiments, the communication protocol 900 includes standard communication protocols, communication protocols designated by individuals or groups (e.g., communication protocols designated by communication device manufacturers or network providers), or a combination thereof.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of providing relevant information by an electronic device comprising:
displaying first information;
extracting one or more retrieval words in a form of keyword or a form of phrase from the first information;
obtaining, using the one or more extracted retrieval words, second information as relevant information related to the first information;
emphasizing objects corresponding to the one or more retrieval words on the first information; and
displaying, when detecting the selection of at least one of the emphasized objects, the second information including the selected objects.

2. The method of claim 1, wherein the first information comprises data displayed as a text-based application is executed.

3. The method of claim 2, wherein the text-based application comprises an email application, a text message application, a document application and a web browser.

4. The method of claim 1, wherein obtaining the second information comprises:
transmitting, when extracting one or more retrieval words from the first information, the one or more extracted retrieval words to an external device through a network;
receiving the searched result information corresponding to the one or more extracted retrieval words from the external device; and
storing the received, searched result information, and
wherein displaying the second information comprises:
displaying information including the selected object from the stored and searched result information.

5. The method of claim 1, wherein emphasizing objects corresponding to the one or more retrieval words comprises emphasizing objects on a user interface of a list form or a tab form.

6. The method of claim 5, wherein displaying the second information comprises displaying, when detecting the selection of at least one of the objects on the user interface, the second information including one or more retrieval words corresponding to the selected object.

7. The method of claim 1, wherein displaying the second information comprises displaying the second information on a user interface of a list form or a tab form.

8. The method of claim 7, further comprising:
obtaining third information searched based on an original text of the first information; and
displaying the third information on part of the user interface.

9. The method of claim 1, wherein displaying the second information comprises obtaining, when detecting the selection of at least one of the emphasized objects, the second information from a memory of the electronic device by using a retrieval word corresponding to the selected object.

10. An electronic device comprising:
a display configured to display first information as a text-based application is executed and second information related to the first information;
a memory configured to store a mapping table where keywords and phrases used to obtain second information as relevant information related to the first information are mapped to the second information and the mapped results are stored; and a database (DB) configured to obtain the second information; and
one or more processors coupled to the memory, the one or more processors configured to:
control a communication module to search for the second information from an external DB,
control the display to display the first information;
extract one or more retrieval words in a form of keyword or a form of phrase from the first information;
obtain, using the one or more extracted retrieval words, the second information as relevant information related to the first information;
emphasize objects corresponding to the one or more retrieval words on the first information; and
set to display, when detecting the selection of at least one of the emphasized objects, the second information including the selected objects.

11. The electronic device of claim 10, wherein the first information comprises data displayed as a text-based application is executed.

12. The electronic device of claim 11, wherein the text-based application comprises an email application, a text message application, a document application and a web browser.

13. The electronic device of claim 10, wherein the one or more processors are configure to:
transmit, when extracting one or more retrieval words from the first information, the one or more extracted retrieval words to an external device through a network;
receive the searched result information corresponding to the one or more extracted retrieval words from the external device;
store the received, searched result information; and
display information including the selected object from the stored, searched result information.

14. The electronic device of claim 10, wherein one or more processors are further configured to emphasize objects by at least one of the following: underlining, shading, and thickening the objects.

15. The electronic device of claim 10, wherein the one or more processors are configure to emphasize objects on a user interface of a list form and/or a tab form.

16. The electronic device of claim 15, wherein the one or more processors are configure to control the display to display, when detecting the selection of at least one of the objects on the user interface, the second information including one or more retrieval words corresponding to the selected object.

17. The electronic device of claim 10, wherein the one or more processors are configure to control the display to display the second information on a user interface of a list form or a tab form.

18. The electronic device of claim 17, wherein the one or more processors are configure to obtain third information searched based on the original text of the first information, and display the third information on part of the user interface.

19. The electronic device of claim 10, wherein the one or more processors are configure to obtain, when detecting the selection of at least one of the emphasized objects, the second information from a memory of the electronic device by using a retrieval word corresponding to the selected object.

20. A computer-readable recording medium storing software for providing relevant information by an electronic device, comprising instructions that cause one or more processors to:
display first information;
extract one or more retrieval words in a form of keyword or a form of phrase from the first information;
obtain, using the one or more extracted retrieval words, second information as relevant information related to the first information;
emphasize objects corresponding to the one or more retrieval words on the first information; and
display, when detecting the selection of at least one of the emphasized objects, the second information including the selected objects.
